(19) United States
(12) Patent Application Publication
(10) Pub. No.: US 2002/0133734 A1
(43) Pub. Date: Sep. 19, 2002

(54) Network restoration capability via dedicated hardware and continuous performance monitoring

(76) Inventors: Jithamithra Sarathy, Atlantic Highlands, NJ (US); Raj Acharya, Ocean, NJ (US); Roman Antosik, Colts Neck, NJ (US); Jayanta Das, Morganville, NJ (US); Bharat Dave, Howell, NJ (US); Chinnabbu Ekambaram, Freehold, NJ (US); Khem Gandhi, Marlboro, NJ (US); Frank Hujber, Mercerville, NJ (US); Mohammad Laham, Basking Ridge, NJ (US); Frederick Renner, West Long Branch, NJ (US); Ronald Simprini, Red Bank, NJ (US); Boris Stefanov, Gillette, NJ (US); Tan B. Thai, Jackson, NJ (US); Ravi Vora, Freehold, NJ (US)

Correspondence Address: KAPLAN & GILMAN , L.L.P., 900NROUTE 9 NORTH, WOODBRIDGE, NJ, 07095, US

(21) Appl. No.: 09/931,725

(22) Filed: Aug. 17, 2001

Related U.S. Application Data
(63) Continuation-in-part of application No. 09/852,582, filed on May 9, 2001.
(60) Provisional application No. 60/238,364, filed on Oct. 6, 2000.

(51) Int. Cl. G06F 11/00

(52) U.S. Cl. 714/4

(57) ABSTRACT

A novel solution to fast network restoration is provided. In a network node, dedicated hardware elements are utilized to implement restoration, and these elements are linked via a specialized high speed bus. Moreover, the incoming and outgoing optical signals to each input/output port are continually monitored and their status communicated to such dedicated hardware via the high-speed bus. This provides a complete snapshot in virtually real time of the state of each input port on the node, and the switch map specifying the inter portal connections, to the dedicated control and restoration hardware. The specialized hardware detects trouble conditions and reconfigures the switching fabric. The invention enables a very fast and efficient control loop between the I/O ports, switch fabrics, and controllers.

In a preferred embodiment the hardware comprises a Connection Manager and an Equipment Manager. The switching fabric control is also linked via the same high-speed bus, making changes to input/output port assignments possible in less than a millisecond and thus reducing the overall restoration time. In a preferred embodiment the status information is continually updated every 125 microseconds or less, and the switch fabric can be reconfigured in no more than 250 microseconds from occurrence of a trouble condition.

### CROSS REFERENCE TO RELATED APPLICATIONS

This application claims the benefit of U.S. Provisional Patent Application No. 60/238,364 filed on Oct. 6, 2000, and is a continuation in part of U.S. patent application Ser. No. 09/852,582, filed on May 9, 2001, the specification of which is hereby incorporated herein by reference.

### TECHNICAL FIELD

This invention relates to optical data networks, and more particularly relates to fast restoration of data flow in the event of disruption.

### BACKGROUND OF THE INVENTION

In the modern core/backbone optical data network, large amounts of data, including voice telephony, are carried on optical pipes with bands with up to 40 gigabits per seconds. At these speeds, traffic disruptions caused by fiber cuts or other catastrophic events must be quickly restored by the finding of alternate routing paths in the network. In fact, in this context, the word “quickly” is an understatement since these optical pipes tend to be shared by a wide variety of customers and the diversity of and potentially critical data that could be affected by a break in one of these such optical pipes is enormous. Further, at a bit rate of 40 gigabits per second, a temporary loss of data for even a few milliseconds while a restoration pathway is being set up translates to the loss of significant amounts of data.

Restoration time tends to be dependent upon how fast an optical switch fabric can be reconfigured and how quickly the optical signal characteristics at the input and output transmission ports can be measured. This reconfiguration process may require several iterations before an optimal signal quality is even achieved, especially if the optical switch fabric is based upon 3D MEMS mirror technology. Thus, a modern high-speed optical data network really cannot function without an exceedingly fast mechanism for signal monitoring and switch reconfiguration to ensure absolute minimum restoration times.

FIG. 1 depicts a typical control architecture for a network node in a modern optical network. The depicted system is essentially the current state of the art in modern optical networks. In what follows, the typical steps in identifying a trouble condition and implementing restoration of the signal will be described, along with the temporal costs of each step in the process. It is noted that these temporal costs are high, and significant data will be lost under such a system.

An incoming optical signal 101 enters an input port in an I/O module 102 and is split (for 1+1 protection) into two identical signals 101A and 101 B, and sent to the switch fabrics 103. The switch fabrics 103 are also 1:1 protected. After switching, both copies of the incoming signal, now collectively an output signal 101AA and 101BB, are routed to an output module 104 in which one copy of the signal (101AA or 101BB) is selected and routed to an output I/O port as outgoing signal 160. Signal monitoring can be performed on the incoming optical signal 101 as well as on the outgoing signal 160.

Such signal monitoring is generally implemented in hardware and thus has minimal execution time, generally on the order of less than 10 milliseconds, and thus adds little temporal cost to the control methodology.

If a trouble condition is detected at the input monitoring point 150, such as a loss of signal condition in the incoming optical signal 101, or if a trouble condition is detected at the output monitoring point 151, such as signal degradation in the output signal 160, then an interrupt must be sent to the system controller 110 via the I/O controller 120. It is noted that the monitoring hardware and the connections to the I/O controller are not shown in FIG. 1, for simplicity. The system controller 110 reads the I/O pack via I/O controller 120 to examine the state of the key port parameters. This operation is mostly software intensive, with interrupt latency and message buffer transfer times on the order of 500 milliseconds.

Next, the system controller 110 analyzes the I/O pack data and informs the restoration controller 130 to initiate restoration. These operations are handled in software and generally, in the described state of the art system, require on the order of 10 milliseconds to accomplish.

Finally, the restoration controller 130 computes a new path and port configuration, informs the system controller 110, which then informs the switch controller 135 to reconfigure the switch fabric 103 for the new I/O port connectivity. The restoration controller 130 then notifies its nodal neighbors (not shown, as FIG. 1 is depicts a network element in isolation) of the new configuration. This latter step entails software operations and takes on the order of 500 milliseconds to accomplish.

Thus, the total restoration time in the modern state of the art optical data network is comprised of internal processing time at the network element of approximately one second (actually 1.020 seconds or slightly less) plus the tₙ₂ₙ, or the external node to node messaging time.

To summarize, prior art systems operate by monitoring the incoming optical signal upon entry and prior to being outputted, and if a trouble condition is detected, then and only then is an interrupt sent to a system controller via an I/O controller. The system controller receives the interrupt message, reads the I/O pack, and informs a restoration controller to initiate restoration. Upon receiving this message from the system controller the restoration controller computes new path and port configurations and sends a message to the system controller to reconfigure the switch fabric. The restoration controller (“RC”) notifies all nodal neighbors of the new configuration. This is thus an alarm-based system where nothing happens unless a trouble condition is detected; then, by a series of interrupts and messages, each with their inherent delays, latencies and processing times, action is taken. Because decision making is centralized in the system controller (“SC”), and because there is no restoration specific dedicated high speed link between the SC, the RC and the switch controller (“SWC”), the entire detection and restoration process is software and communications intensive. It is thus time consuming, taking some 1.020 seconds at the network element level, plus any internodal messaging times, to implement. At a data rate of 40 Gb/sec, this means that some 5 gigabytes of data are lost while restoration occurs at the nodal level alone.

What is needed is a faster method of detecting trouble conditions and communicating these conditions to nodal control modules.

What is further needed is a method and system of restoration implementation so as to significantly reduce the temporal costs of detection and restoration, the benefits of which will be more and more significant as data rates continue to increase.

### SUMMARY OF THE INVENTION

The present invention provides a novel solution to fast network restoration. In a network node, dedicated hardware elements are utilized to implement restoration, and these elements are linked via a specialized high-speed bus. Moreover, the incoming optical signals to each input port are continually monitored and their status communicated to such dedicated hardware via such high-speed bus. This provides a complete snapshot, in virtually real time, of the state of each input port on the node. The specialized hardware automatically detects trouble conditions and reconfigures the switching fabric.

In a preferred embodiment the hardware comprises a Connection Manager and an Equipment Manager. The switching fabric control is also linked via the same high-speed bus, making the changes to input/output port assignments possible in less than a millisecond and thus reducing the overall restoration time. In a preferred embodiment the status information is continually updated every 125 microseconds or less, and the switch fabric can be reconfigured in no more than 250 microseconds.

### BRIEF DESCRIPTION OF THE DRAWINGS

FIG. 1 depicts a typical optical network node control structure;

FIG. 2 depicts the optical network node control and restoration structure according to the present invention;

FIG. 3 depicts the contents of a status information frame according to the method of the present invention; and

FIG. 4 depicts a more detailed view of the structure of FIG. 2 in a particular embodiment of the present invention.

### DETAILED DESCRIPTION OF THE PREFERRED EMBODIMENT

The concept of the present invention is a simple one. As opposed to prior art systems wherein restoration is triggered only upon the detection of a fiber cut or other catastrophic event, and the propagation of the resultant alarm signal through the control architecture and switching fabric, the method and system of the present invention significantly reduce the time it takes for the system to recognize traffic disruption and restore an alternative traffic path by utilizing dedicated hardware and high speed control data links. The present invention continually updates the optical signal quality status from all of the optical interface boards bringing incoming optical signals into a network node. The high speed control data lines interconnect the optical I/O modules to the system modules concerned with reconfiguring data paths and controlling the switch fabric, thus obviating the temporal costs of propagating an alarm interrupt and the associated intermodule sequential signaling.

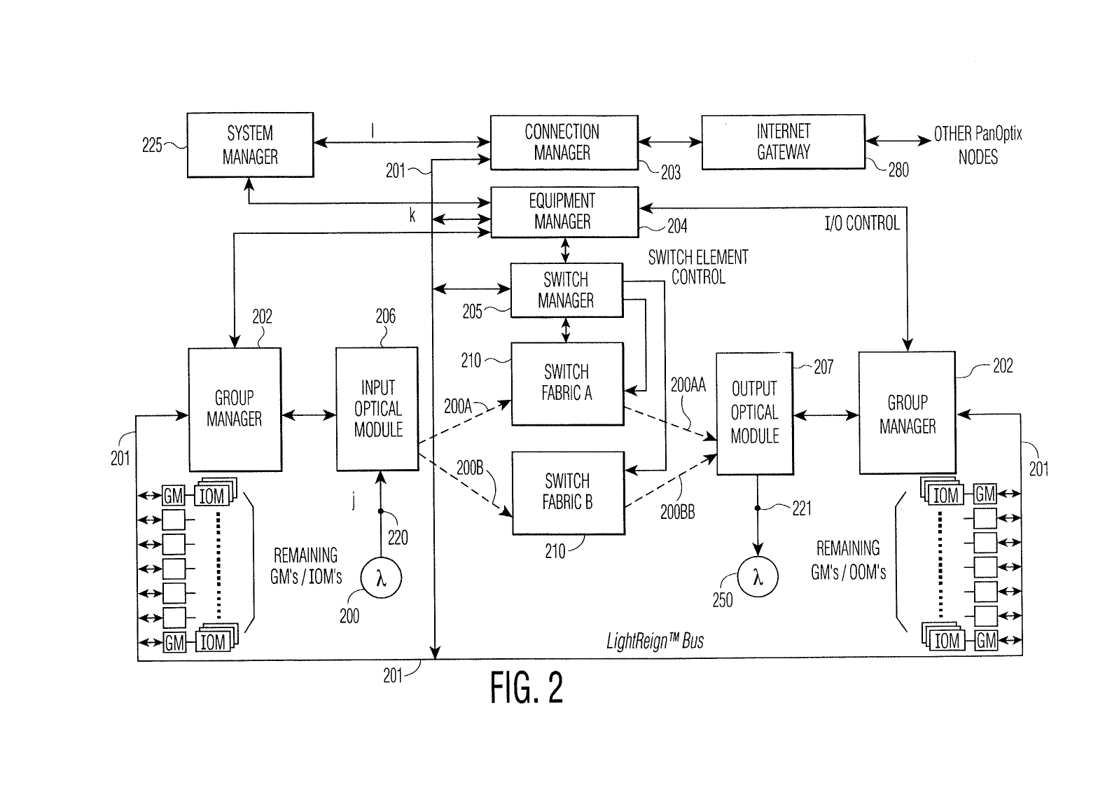

The system components and the method of the invention will now be described with reference to FIGS. 2, 3, and 4.

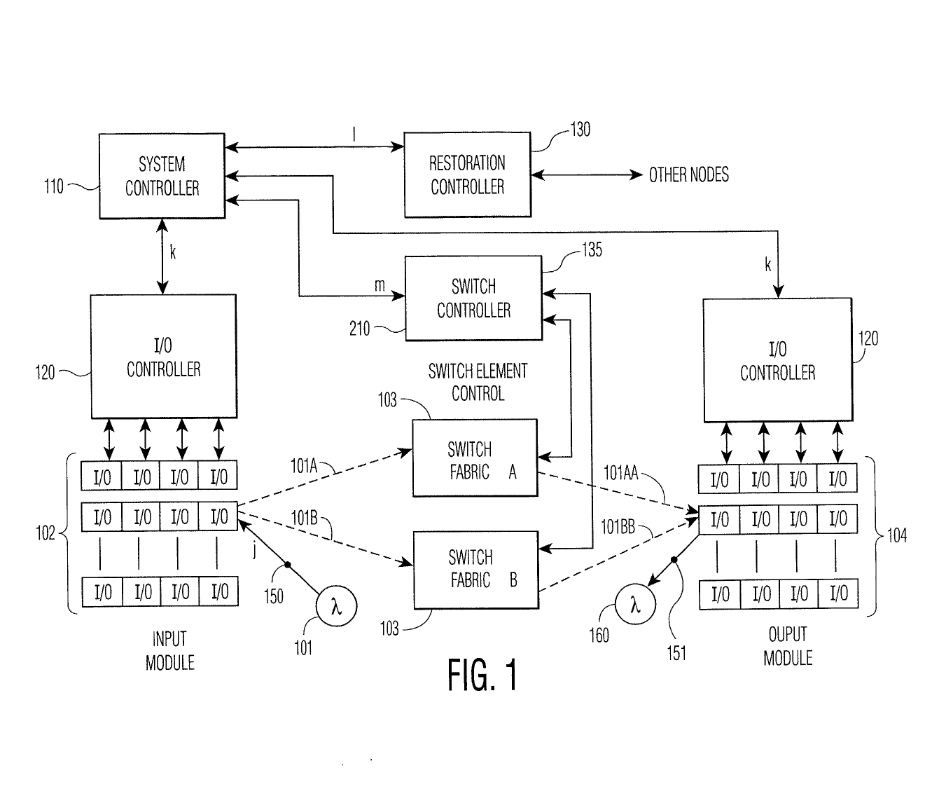

FIG. 2 is a system level drawing of a network node's optical performance monitoring and restoration system. With reference to FIG. 2, one of the main differences between the invention as depicted in FIG. 2 and the state of the art system as depicted in FIG. 1, is the existence of the high speed bus 201 which connects the group managers (“GM”s) 202 to the connection manager (“CM”) 203, the equipment manager (“EM”) 204 and the switch manager (“SWM”) 205. The group managers 202 on the left side of the drawing are each responsible for controlling a number of Input Optical Modules (“IOM”s) 206. In an exemplary embodiment of the invention, each group manager will control 16 input optical modules 206 each having four input lines; with 8 logical group managers 202 in total. The term logical, in this context, is used to designate the number of GMs actually active at any one time. Various embodiments may use load sharing or some type of protection so as to actually have two or more physical GMs for each logically active GM in the system. Thus, in a preferred embodiment, to support 8 active GMs there will be 16 physical GMs, the excess 8 utilized for load sharing of half the capacity of the logical 8 GMs, or for protection, or for some combination thereof. The 8 active GMs each controlling 16 IOMs 206, with each IOM having four input lines, gives a total of 8×16×4 or 512 input lines at the network nodal level.

Group managers 202 also control output optical modules 207. Thus, as well, there are an equal number, 8 in the exemplary embodiment described above, of group managers 202 each controlling 16 output optical modules 207, each output optical module having the same number of output lines, namely 4 in this exemplary embodiment, as an input optical module 206 has input lines. There will, in this example, thus be a total of each of 64 input and 64 output lines per GM 202, and thus overall 512 input and 512 output lines in the entire system of this exemplary embodiment. Any number of group managers 202 could be used, however, as well as any number of optical modules assigned to each GM, and any number of input/output lines per optical input/output module, as design, efficiency, and cost considerations may determine. In a preferred embodiment the I/O lines will be bi-directional, and the logical IOMs and OOMs bi-directional as well and thus physically identical.

Given the structure of FIG. 2 what will be next described is an example network nodal level restoration sequence.

An incoming optical signal 200 to the network node terminates on an input optical module or IOM 206. For protection purposes the incoming signal is split into two identical copies 200A and 200B and sent to parallel switch fabrics 210. After switching, both copies of the original input signal 200AA and 200BB, now a pair of output signals, are routed to an output optical module or OOM 207, in which a copy of the signal (200AA or 200BB) is selected and routed to an output I/O port as the outgoing signal 221. Signal monitoring is performed on an incoming signal at point 220, prior to its entry into the optical module, and on an outgoing signal at point 221, after its exiting form an optical module. This process is primarily a hardware function, and requires less than 10 milliseconds to accomplish.

It is noted that in the continuous monitoring protocol to be described below, the input side (i.e. that measured at point 220) is referred to as receive, and the output side (i.e. that measured at point 221) is referred to as transmit.

Devices to monitor the incoming signal are generally well known in the art, and specific examples of specialized and efficient signal monitoring devices are described, for example, in U.S. patent application Ser. No. 09/852,582, under common assignment herewith.

The optical performance monitoring devices measure the various signal parameters, such as optical power (“OP”) and optical signal to noise ratio (“OSNR”) for each input and each output port (these may be physically at the same location in bi-directional port structures), and send this information, via the high-speed bus, to the CM 203, EM 204, and SWM 205. Information for the entire set of ports on the shelf (i.e. on the entire network node) is updated every F seconds, where F is the frame interval for the frames sent on the high-speed bus. In a preferred embodiment, F is 125 microseconds, corresponding to 8000 frames per second. If the client data rates are increased however, and significant data would be lost in the time interval equal to two frames on the high speed bus, then the optical signal performance data rate for the high speed bus can be increased—at increased cost—thus decreasing the frame interval F, and increasing the frequency of a complete port update for all N ports in the system.

If a trouble condition is detected at the input 220 (such as loss of signal) or at the output (such as signal degradation) 221, then that condition will be reported on the high speed bus 201 and, as described above, will be forwarded to each of the CM 203 and EM 204 in no more than one cycle of the high-speed bus, or frame interval F. In the preferred embodiment, with the frame interval equal to 125 microseconds, reporting occurs within no more than 125 microseconds, and statistically on the average in half that time. It is noted that an entire frame interval F plus transmission time on the high-speed bus is the absolute maximum time it would take for this information to be communicated to the CM 203 and EM 204, inasmuch as if a trouble condition occurs in a given port, say Port N, right after that port's status has been reported, it will be picked up in the immediately next frame following, or within one frame interval F. Thus, the maximum interval between occurrence of a trouble condition at a given port and its reporting on its high speed bus timeslot to the CM 203 and EM 204 is the frame interval of 125 microseconds, as any transmission time within the bus is negligible.

Once reported on the bus, hardware within both the CM 203 and the EM 204, which continually monitors the data from frame to frame, detects a change-of state, via an interrupt. The CM 203 then initiates an alternate path calculation and notifies neighboring network nodes of the new configuration, while the EM 204 prepares for a switch reconfiguration. This operation involves some software processing, primarily analysis and database lookup, and takes on the order of 5 milliseconds.

Thus, in the preferred embodiment, the total restoration time is comprised of the internal processing time of approximately 15.125 milliseconds plus the tₙ₂ₙ, or the external node-to-node message time. The high speed bus of the present invention offers a substantial decrease in internal detection and processing times when compared to conventional control and messaging architectures (i.e., 15.125 milliseconds versus 1.020 seconds, or nearly 2 orders of magnitude).

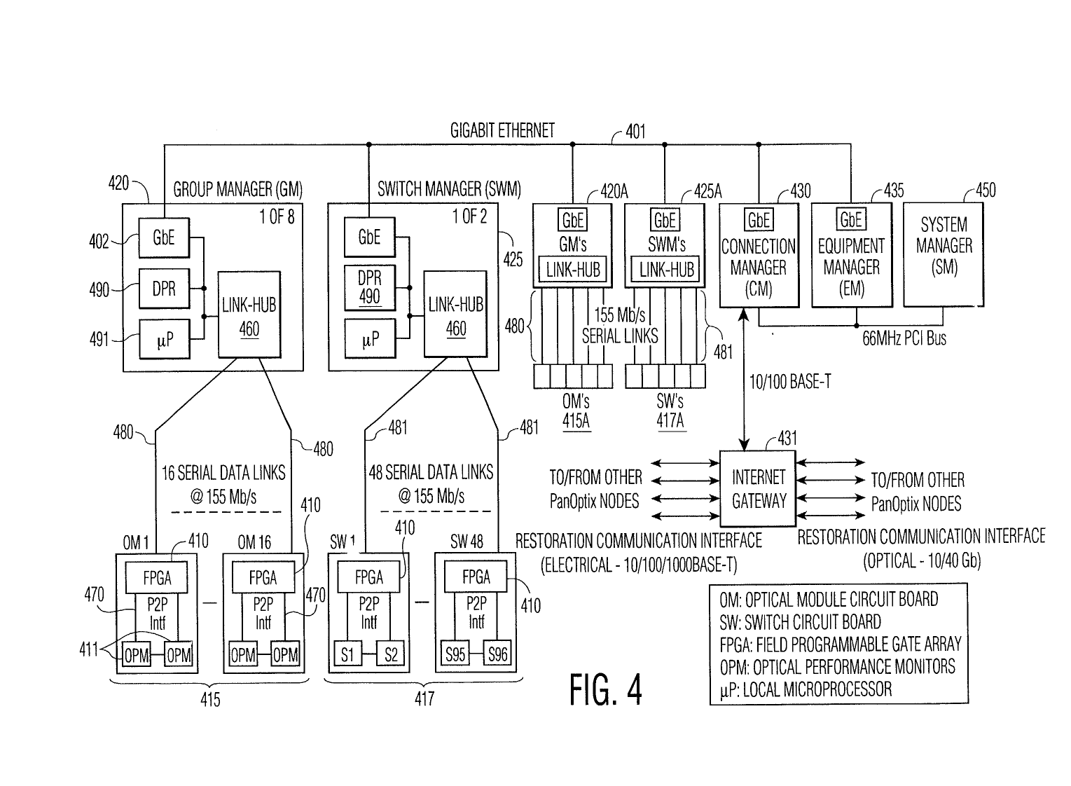

FIG. 4 depicts, from a preferred embodiment of the invention, the system of FIG. 2 in more detail. The additional details therein illustrated will next be described.

Gathering and Formatting Data onto the Bus

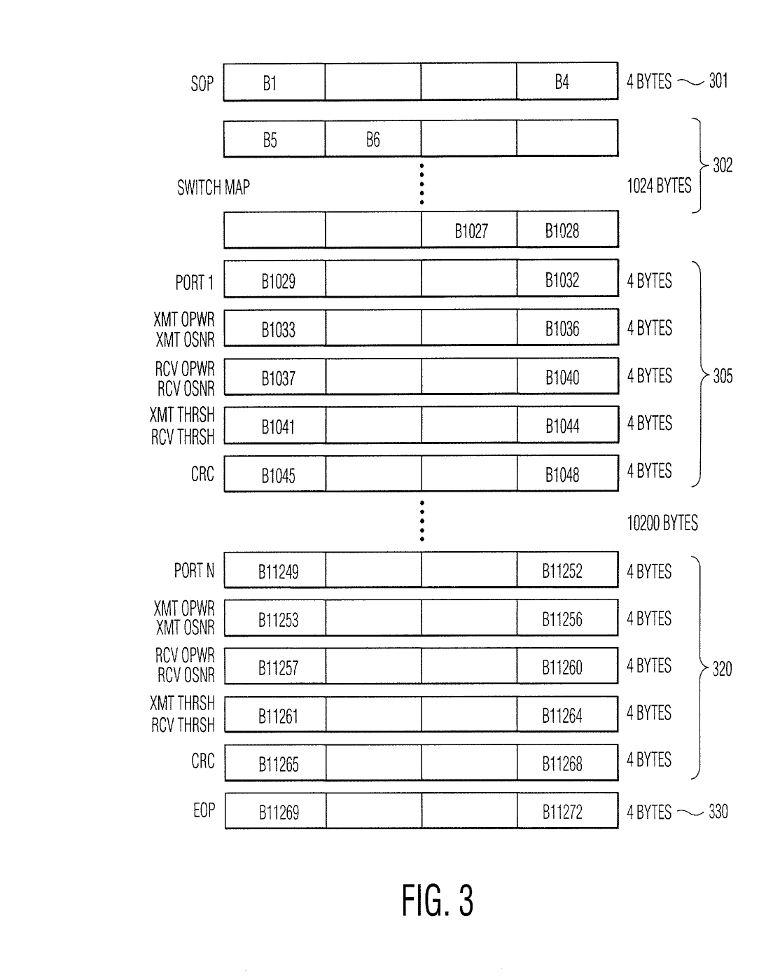

In the system of FIG. 4, The Optical Performance Monitoring (OPM) data is gathered by a dedicated hardware device (e.g., an FPGA, ASIC, or gate array) that is resident on each of the Optical Module (OM) circuit boards. The depicted system uses an FPGA 410 located in each OM 415 for this purpose. The actual monitoring is accomplished by the OPM device 411. In the depicted system, as described above, the logical IOM and OOM are actually one physical bidirectional OM 415. As described above, in this example there are 8 GMs 420 in the system, each controlling 16 OMs 415, each in turn having 4 bi-directional lines. The Figure shows one GM 420 on the top far left, and the remainder at the top center of the figure. The interface to the OPM devices 411 is a direct, point-to-point, parallel interface 470 through which the OPM devices 411 are sampled. The interface is programmable, is under software control, and in this embodiment can support up to one million 16-bit samples per second. The data that is collected is then forwarded from each OM 415 to the OM higher level controller, the Group Manager (GM) 420, through a 155 Mb/s serial data link 480. The data is formatted essentially as shown in FIG. 3, as described below, with the exception that the Switch Map 302 (with reference to FIG. 3) is not included.

In the depicted embodiment, each of the sixteen OM circuit boards 415 in an I/O shelf (such is the term for the total network nodal, or network element, system, comprising various boards and subsystems) pass their respective data to their Group Manager 420 controller via separate 155 Mb/s serial data links. In the 512×512 port configuration, each OM board 415 transmits 88 bytes of data (4 ports worth, recall each OM 415, 415A has four optical ports in the depicted exemplary embodiment) to its GM controller 420. At a serial bit rate of 155 Mbit/sec, this transaction requires about 4.6 microseconds. This data transmission is repeated on each of the other OM boards 415A in the other I/O shelves. Each GM 420, 420A contains a link-hub device 460 that terminates the sixteen 155 Mb/s data links 480 from all of its subtending OM circuit boards 415, 415A. The link-hub device 460 on the GM 420 is a dedicated hardware device (such as, e.g., a FPGA, ASIC, or Gate Array) that (i) collects the data from all of the 16 OM serial links 480, (ii) adds the current state of the Switch Map (which is sourced by the switch manager (“SWM”) 425, 425A and stored in memory on the GM 420, 420A), (iii) formats the data according to the protocol depicted in FIG. 3, and (iv) transfers the data to the Dual Port Ram (DPR) 490 on the GM 420 (not shown in the other GMs 420A for simplicity). The transfer speed from the FPGA (Link-Hub) 460 to the DPR 490 is 80 Megabytes/second. This is based on a 32-bit wide DPR data bus, with an access time of 20 ns and an FPGA (Link-Hub) internal processing time of 30 ns (this number is arrived at as follows: 32 bits/50 ns=4 bytes/50 ns=1 byte/12.5 ns=80 MB/s). Since each GM must collect and store 88 bytes, as described above, from each of its 16 OM boards, the total transfer time is approximately 18 microseconds (1408 bytes*12.5 ns=17.6 us). It is understood that these specifications are for the depicted exemplary embodiment. Design, cost, and data speed considerations may dictate using other schema in various alternative embodiments that would have varying results.

The DPR memory space 490 where the data is stored acts as a transmit buffer for the high-speed bus, here shown as a GbE interface, whose I/O forms the physical high-speed bus. In normal operation, handshaking between the FPGA 460 and DPR 490 keeps the transmit buffer up-to-date with the current OPM data, while the GbE interface 402 packetizes the data from the buffer and sends it out on to the high-speed bus 401.

All of the second-level controller GM's 420, 420A and SWM's 425, 425A in the system are equipped with these elements of the high-speed bus interface (uP 491, DPR 490, GbE 402, link-hub 460, which are shown in detail in the leftmost GM 420). In addition, the first level controllers, Equipment Manager (EM) 435 and Connection Manager (CM) 430, are also equipped with GbE interfaces that connect with the high-speed bus. As well, all of the first level controllers can communicate with one another via a compact PCI bus. The Internet Gateway (IG) circuit board 431, which can be considered an extension of the CM 430, provides the restoration communication channels, both electrical and optical, that are used to signal other network nodes in the network. For example, trouble conditions in a local node that are reflected in the high-speed bus data and seen by the CM 430 can trigger the IG 431 restoration communication channels to inform other nodes to take appropriate path rerouting actions (optical switching) or other remedial action, thus propagating the restoration information throughout the data network.

Extracting and Distributing Data from the Bus

The high-speed bus data is made available to all of the controllers with GbE interfaces, where the packets are received and the payload data (OPM data, switch maps, etc.) is placed in a receive buffer either in on-board memory (as in the case of the CM 430 and EM 435) or in DPR 490 (as in the case of the GM 420, 420A and SWM 425, 425A). For communications in the other direction, data in the receive buffer (DPR 490) on the GM 420, 420A and SWM 425, 425A is extracted by the Link Hub 460 where it is formatted and forwarded to the OM 415 and SW 417 circuit boards over their respective 155 Mb/s serial data links. Each serial data link is terminated in the FPGA 410 resident on said OM and SW boards where the link data is available for update to internal registers in the FPGA where, for example, OPM 411 threshold changes (in the case of the OM 415) or cross-connect changes (in the case of the SW 417) can be initiated.

Data in on-board memory (receive buffer) on each of the CM 430 and EM 435 is extracted and processed by the local microprocessor, labeled as “uP” which in turn can initiate restoration messages (via CM 430 and IG 431) or reconfigure cross-connects and OPM 411 parameters (via EM 435).

Because, in a preferred embodiment, the high-speed bus is a bi-directional, multinode bus, contention is managed in a similar fashion to the CSMA/CD protocol that is used in 10/100Base-T LAN networks.

Bus Specification

In a preferred embodiment, the high speed bus specification is as follows:

1) Transport Medium

i) Inter-Shelf: Optical

ii) Intra-Shelf: Electrical

2) Transport Protocol

i) Inter-Shelf: GbE

ii) Intra-Shelf: Proprietary

3) Transport Bit Rate

i) Inter-Shelf: 1000 Mb/s

ii) Intra-Shelf: 66 Mb/s

4) Transport Medium: Gigabit Ethernet

5) Bit Rate: 1 Gb/s (T_{bit}=1 ns)

6) Frame Interval: 125 microseconds.

7) Timeslots(bits)/Frame: 125,000

8) Maximum Bytes/Frame: 15625 (125,000 bits/frame×1 byte/8 bits)

It is understood that there are numerous other embodiments of the invention, where these parameters can be varied as design, cost and market environment may dictate.

The packet format will next be described with reference to FIG. 3. The following identifiers and their abbreviations comprise the fields utilized in the protocol, as depicted in FIG. 3.

SOP 301: Start-of-Packet Identification

Switch Map 302: Current input/output port association through the optical switch.

Port Number: Bidirectional port number identifier for next set of data.

Total number of ports (N) in the example is 512.

Transmit Optical Power (XMT OPWR): Current optical power reading in transmit direction on port currently identified.

Transmit Optical Signal-to-Noise Ratio (XMT OSNR): Current optical SNR reading in transmit direction on port currently identified.

Receive Optical Power (RCV OPWR): Current optical power reading in receive direction on port currently identified.

Receive Optical Signal-to-Noise Ratio (RCV OSNR): Current optical SNR reading in receive direction on port currently identified.

Transmit Thresholds (XMT THRSH): Indication of optical power and optical SNR threshold crossings in the transmit direction on port currently identified.

Receive Thresholds (RCV THRSH): Indication of optical power and optical SNR threshold crossings in the transmit direction on port currently identified.

CRC: Cyclical Redundancy Checksum over current port data.

EOP: End of Packet identifier.

In the depicted exemplary embodiment of FIG. 3, the following fields comprise one frame and each field has the following bytes assigned to it. The first four bytes of each frame have an SOP or start of packet identification; this is depicted as 301 in FIG. 3 being bytes B1 through B4. The next block of bytes comprises a switch map 302. This gives the totality of port assignments connecting a given input port to a given output port. In the depicted example of FIG. 3 there are 1,024 bytes allocated to the switch map because the total number of ports, N, in this example is 512. In general, the switch map field as a whole will use 2N bytes, where N equals the total number of ports on a system. The next block of bytes consists of the optical signal parameters for Port 1, and is identified as 305 in FIG. 3. The first four bytes give the port ID, being bytes B1029 through B1032, as shown in FIG. 3. The next two bytes, being B1033 and B1034 contain the transmit optical power of port 1 and the following two bytes, B1035 and B1036, give the transmit optical signal to noise ratio. In a similar manner the next four bytes, being B1037 through B1040 give the receive optical power and the receive optical signal to noise ratio, respectively, for Port 1. It is noted that transmit values are measured at points 221 in FIG. 2, and receive values at points 220 in FIG. 2. The next four bytes, being B1041 through B1044, give the transmit thresholds and the receive thresholds, and the final four bytes give the cyclical redundancy check sum over the entire port data; these are depicted as bytes B1045 through B1048 in FIG. 3. Thus, a given port requires 20 bytes to fully encode the optical signal parameters. In the example depicted in FIG. 3 there are 512 total ports; therefore, 10,240 bytes are used to cover all the ports. The interim ports, beings ports 2 through N-1 are not shown, merely designated by a vertical line comprised of dots between bytes B1048 and B11,249 in FIG. 3. FIG. 3 ends showing the identical fields for port N as shown for Port 1, which occupies 20 bytes from B11249 through B 11268; that whole block of 20 bytes is designated as 320 in FIG. 3. Finally, at the end of a frame, in parallel fashion to the beginning of the frame, there is an end of packet identifier occupying four bytes, being bytes B11269 through B11272 in FIG. 3, therein designated 330.

As can be seen the total number of bytes utilized by a frame in the depicted example of FIG. 3 does not equal the specified maximum bytes per frame at a bit rate of one gigabyte per second. Thus, there is expansion room within the frame for a larger number of ports overall or possibly additional informational bytes. Adding up the depicted bytes we find a total of 11,272 bytes utilized; the maximum is 15,625 under the depicted bit rate in this example. Increasing the bit rate will, obviously, allow more data per frame or the same frame to be transmitted with a shorter frame interval, as may be desired by the user in given circumstances. Alternatively the bytes per frame can be decreased and the frame interval F decreased as well, thus increasing the update frequency.

Applicants' invention has been described above in terms of specific embodiments. It will be readily appreciated by one of ordinary skill in the art, however, that the invention is not limited to those embodiments, and that, in fact, the principles of the invention may be embodied and practiced in other devices and methods. Therefore, the invention should not be regarded as delimited by those specific embodiments but rather by the following claims.

What is claimed:

1. A method of fast restoration in a data network, comprising:
employing dedicated restoration hardware elements in a network node; and
linking said dedicated restoration hardware elements via a high-speed bus.

2. The method of claim 1, where said dedicated restoration hardware comprises a connection manager and an equipment manager.

3. The method of claim 1, further comprising connecting all optical inputs and outputs to specialized controllers, each also connected to the high-speed bus

4. The method of claim 3, further comprising connecting a switch manager to said high-speed bus, where said switch manager controls all switch elements.

5. The method of any of claims 1-4, where the signal parameters from all input and output optical signals are repeatedly updated on the high-speed bus.

6. The method of claim 5, where said updating occurs in near real time, and in not longer than 125 μsec intervals.

7. The method of claim 6, where said signal parameters include at least one of optical power (OP), optical signal to noise ratio (OSNR), and threshold crossings of those parameters.

8. The method of claim 7, where the optical parameters are measured on both the incoming signal (receive side) and outgoing signal (transmit side).

9. A method of continuous monitoring of optical signals in a data network node, comprising:
continually monitoring defined optical signal parameters; and
continually communicating the monitored results to the node's controllers.

10. The method of claim 9, where the optical signal parameters include at least one of optical power (OP), optical signal to noise ratio (OSNR), and threshold crossings of those parameters.

11. The method of claim 10, where the optical parameters are measured on both the incoming signal (receive side) and outgoing signal (transmit side).

12. The method of claim 10, where the thresholds for each of the optical parameters can be set by the user.

13. The method of any of claims 9-12, where the monitoring results are updated at least every 125 microseconds.

14. A system for continuous monitoring of input signals in a data network node, comprising:
signal parameter measuring devices;
a high speed bus connecting them with the node controllers.

15. The system of claim 14 where the node controllers comprise a connection manager and an equipment manager.

16. The system of claim 15, where the signal parameter measuring devices measure at least one of the following parameters:
optical power (OP)
optical signal to noise ratio (OSNR); and
threshold crossings of those parameters.

17. The system of any of claims 14-16, where the system further operates to accomplish restoration by identifying a defined change in said signal parameters, and reconfiguring the nodal switch fabric.

18. A data network wherein high speed restoration occurs, comprising nodes comprising the systems of any of claims 14-17.

19. A frame protocol for the continuous monitoring of a network node, comprising:
a start of frame flag;
all input to output port associations; and
optical signal parameters for each port.

20. The protocol of claim 19, additionally comprising an end of frame flag.

21. The protocol of claim 20, where said optical signal parameters include at least one of optical power (OP), optical signal to noise ratio (OSNR), and threshold crossings of those parameters.

22. The protocol of claim 21, where the optical parameters are measured on both the incoming signal (receive side) and outgoing signal (transmit side).

23. Apparatus for continual signal performance monitoring in an optical data network node comprising:
devices to monitor optical signal performance parameters;
dedicated hardware for formatting the monitoring results; and
a high-speed bus.

24. The apparatus of claim 23, where communications on the high-speed bus is restricted to messages communicating or relating to:
signal performance data,
the nodal switch map, and
restoration or reconfiguration.
